(19) United States
(12) Patent Application Publication
(10) Pub. No.: US 2005/0112383 A1
(43) Pub. Date: May 26, 2005

(54) Undercoating layer material for lithography and wiring forming method using the same

(76) Inventors: Takeshi Tanaka, Kanagawa (JP); Yoshio Hagiwara, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/967,258

(22) Filed: Oct. 19, 2004

(30) Foreign Application Priority Data
Nov. 20, 2003 (JP) 2003-390983
Sep. 15, 2004 (JP) 2004-268782

(51) Int. Cl. B32B 9/04

(52) U.S. Cl. 428/447

(57) ABSTRACT

An undercoating layer material for lithography, containing polysiloxane and an organotitanium compound having no alkoxy group; and a method for forming a wiring including a step of applying the undercoating layer material onto a substrate and curing to form an undercoating layer and forming a photoresist layer thereon; a step of removing by dry etching the exposed portion of the undercoating layer which is not covered with the photoresist pattern; a step of forming a predetermined wiring pattern using the photoresist pattern and the patterned undercoating layer as masks; and a step of removing the undercoating layer and photoresist pattern remaining on the substrate. The undercoating layer material is advantageous that the storage stability, the form of the lower portion of the resist pattern, and the burying properties are excellent and no voids are found.

### BACKGROUND OF THE INVENTION

1) Field of the Invention

The present invention relates to an undercoating layer material for lithography, which is provided on a substrate prior to forming a photoresist layer on the substrate to prevent the light for exposure reflected by the surface of the substrate from entering into the photoresist during patterning of the photoresist, improving the resolution of the photoresist pattern, and a method for forming a wiring using the undercoating layer material. More particularly, the present invention is concerned with an undercoating layer material for lithography having an ability to absorb light in a wide range of wavelength by virtue of an organotitanium compound having no alkoxy group contained in the material, and a method for forming a wiring using the undercoating layer material.

2) Description of the Related Art

In the production of integrated circuit devices, for obtaining an integrated circuit having higher degree of integration, the scale of fabrication in a lithography process has been downsized. The lithography process is a method in which a photoresist composition is applied onto a substrate, and irradiated with light for exposure through a mask pattern by means of an exposure system, and the pattern thus formed is then developed using an appropriate developer, to obtain a desired pattern.

As the light for exposure, generally, a g-ray (wavelength: 436 nm), an i-ray (wavelength: 365 nm), a KrF excimer laser (wavelength: 248 nm), or an ArF excimer laser (wavelength: 193 nm) is used. Recently, an F₂ excimer laser (wavelength: 157 nm) has drawn attention as the next-generation light having a short wavelength. Short-wavelength light for exposure, typically an F₂ excimer laser enables formation of a fine resist pattern, as compared to conventional light for exposure.

In the patterning of a photoresist layer by irradiation with such light for exposure, a phenomenon occurs in which the light for exposure penetrates the resist layer, and the penetrating light is reflected by the surface of the underlying layer and the reflected light enters a portion of the photoresist which should not be exposed. This phenomenon, that is, the reflected light entering into the photoresist layer causes a problem that the pattern resolution of the photoresist is lowered. For solving the problem, a method has conventionally been employed in which, prior to forming a photoresist layer on a semiconductor substrate, a resin composition including a material having a property to absorb light for exposure is applied to the substrate to form an undercoating layer, and then a photoresist layer is formed on the undercoating layer. This undercoating layer is referred to as a primary antireflection film in terms of the desired effect of the film.

As the primary antireflection film, inorganic films, such as a titanium film, a titanium dioxide film, a titanium nitride film, a chromium oxide film, a carbon film, and an α-silicon film, and inorganic-organic hybrid antireflection films having both inorganic and organic properties are known.

However, in formation of the inorganic antireflection film, a vacuum deposition, CVD, or sputtering method must be used, and hence there is a disadvantage that specialized equipment, such as a vacuum deposition device, a CVD device, or a sputtering device, is required. On the other hand, the inorganic-organic hybrid antireflection film has problems that the film cannot satisfactorily prevent halation or stationary wave, and the bonding or adhesion of the antireflection film to the substrate or resist film is unsatisfactory. In addition, there is a problem of intermixing, leading to deterioration of the resist pattern, e.g., removal failure or bottom trailing.

For solving the problems, an inorganic-organic hybrid antireflection film is disclosed, which has high antireflection effect and causes no intermixing, and on which a resist pattern can be formed with excellent resolution and accuracy using a simple spin coating method (Patent Document 1: Japanese Patent Application Laid-open No. H11-258813).

Further, as the resist becomes finer and is reduced in thickness, a problem arises that the etching rate of the resist and that of the undercoating layer (antireflection film) are close to each other and hence microfabrication of the organic material or inorganic material in the layer under the antireflection film is difficult, and there is a problem that the antireflection film or the organic material or inorganic material in the underlying layer suffers a damage in the O₂ plasma ashing for stripping the resist.

For solving the problems, a composition for a film under the resist, having a resistance to O₂ plasma ashing for stripping the resist, is disclosed (Patent Document 2: Japanese Patent Application Laid-open No. 2000-292931).

However, in the composition for a film under the resist having a resistance to O₂ plasma ashing, an alkoxytitanium compound is used as a catalyst in the constituents of the composition, and hence easily undergoes hydrolysis with water, making handling of the composition difficult in terms of controlling the molecular weight. In addition, the storage stability of the composition is poor.

Further, when a conventional composition is used in formation of semiconductor wiring using a damascene process, a problem occurs that the buried material properties are poor, generating voids in the film.

On the other hand, as the technology progresses in the improvement of the undercoating layer material for lithography, the currently used undercoating layer material which absorbs light in a certain range of wavelength may become unsuitable for the newly developed light for exposure. For obtaining a new undercoating layer material suitable for exposure with such a light, studies must be made on the individual constituents of the undercoating layer material, which require a prolonged time and cumbersome operations. Further, the undercoating layer material for lithography that has conventionally been used becomes useless and will be abandoned. Therefore, if it is possible to develop a method for easily modifying a conventional undercoating layer material for lithography which absorbs light in a certain range of wavelength for obtaining another undercoating layer material for lithography which absorbs light in another range of wavelength, such a method would be highly advantageous.

In view of the above problems, an object of the present invention is to provide an undercoating layer material for lithography, which is advantageous not only in that it has excellent property to absorb the reflected light and excellent storage stability, but also the problems of lowering of the burying properties and occurrence of voids are solved.

### SUMMARY OF THE INVENTION

The present inventors have made studies for developing an undercoating layer material for lithography with a view to the above problems. As a result, they have found that, when the undercoating layer material contains an organotitanium compound having no alkoxy group not as a catalyst but as a light absorbing material, the problems are solved and excellent actions and effects can be obtained.

That is, the undercoating layer material for lithography according to the present invention has a characteristic feature such that it includes an organotitanium compound having no alkoxy group as a light absorbing material.

The present invention having the aforementioned feature thus provides an undercoating layer material for lithography which is advantageous that the property to absorb the reflected light, the storage stability, the form of the lower portion of the resist pattern, and the burying properties are excellent and no voids are found. Further, the present invention provides an undercoating layer material for lithography, which can be formed using a simple spin coating method and causes no intermixing, and on which a resist pattern can be formed with excellent resolution and accuracy.

By the present invention having the aforementioned feature, there is provided an undercoating layer which has a resistance to O₂ plasma ashing for stripping the resist, and which can be subjected to wet stripping. In addition, an undercoating layer effective in a KrF excimer laser (wavelength: 248 nm), an ArF excimer laser (wavelength: 193 nm), or an F₂ excimer laser (wavelength: 157 nm) is provided.

Further, the method for forming a wiring according to the present invention includes: a photoresist pattern forming step of applying the undercoating layer material for lithography onto a substrate and curing the material to form an undercoating layer, forming a photoresist layer on the resultant undercoating layer, and then subjecting the photoresist layer to exposure and development treatment to form a predetermined photoresist pattern; an undercoating layer patterning step of removing by dry etching the exposed portion of the undercoating layer which is not covered with the photoresist pattern; a wiring pattern forming step of subjecting the substrate to etching using the photoresist pattern and the patterned undercoating layer as masks to form a predetermined wiring pattern; and an undercoating layer removing step of removing the undercoating layer and photoresist pattern remaining on the substrate after forming the wiring pattern.

By using the undercoating layer material for lithography according to the present invention, an undercoating layer for lithography having excellent property to absorb the reflected light can be obtained. In addition, the undercoating layer causes no mixing with the resist layer, and therefore deformation of the lower portion of the pattern can be suppressed, thus making it possible to obtain an excellent rectangular pattern. Further, the undercoating layer can be formed using a simple spin coating method, and has excellent flatness. The material has excellent storage stability and hence is easy to handle.

In addition, the undercoating layer has properties required for the buried material in a dual damascene process, namely, properties such that the burying properties are excellent, occurrence of voids is suppressed, the etching rate is high, and the film can be subjected to wet stripping.

The undercoating layer obtained using the undercoating layer material according to the present invention is an inorganic antireflection film, and hence has a fast dry etching rate as compared to the resist, and further has an etching rate equivalent to that of an SiO film constituting a low dielectric-constant layer. The undercoating layer can be subjected to wet stripping.

Further, the undercoating layer obtained using the undercoating layer material according to the present invention contains neither an organic light absorber nor an organic resin, and therefore the undercoating layer suffers less damages in a resist reworking treatment (O₂ plasma ashing).

The undercoating layer material for lithography according to the present invention has an ability to absorb light in a range of wavelength, and therefore can impart to a film an ability to absorb light in a wide range of wavelength.

Therefore, unlike the procedure in the prior art, there is no need to make studies on the individual constituents of the undercoating layer material for lithography when the light for exposure is changed, and hence a prolonged time and cumbersome operations are not needed for the development. Further, the undercoating layer material that has been used for lithography can be utilized, leading to effective utilization of materials.

Along with the downsizing of semiconductor integrated circuits, the light for exposure used is reduced in wavelength, and, in a conventional. undercoating layer, the antireflection material has been changed per wavelength of the light for exposure. In contrast, the undercoating layer material for lithography according to the present invention has an absorption at shorter than about 300 nm (e.g., KrF: 248 nm; ArF: 193 nm; F₂: 157 nm), and therefore this sole material can be widely used in the whole range of wavelength as an undercoating layer material for lithography.

These and other objects, features and advantages of the present invention are specifically set forth in or will become apparent from the following detailed descriptions of the invention when read in conjunction with the accompanying drawings.

### BRIEF DESCRIPTION OF THE DRAWING

FIG. 1 is a diagram of the process for forming a wiring structure using lithography.

### DETAILED DESCRIPTIONS

As mentioned above, the characteristic feature of the present invention resides in that the present undercoating layer material for lithography includes at least polysiloxane and an organotitanium compound having no alkoxy group.

While the present invention is explained in detail, the invention is not limited by the embodiments. In the explanations below, commercially available products may be used for each component material, unless otherwise specified.

(1) Undercoating Layer Material for Lithography

(I) Organotitanium Compound Having no Alkoxy Group

It is preferred that the organotitanium compound having no alkoxy group used in the present invention is an organotitanium chelate compound. Among the organotitanium chelate compound, preferred is a titanium acylate compound, and especially preferred is a titanium lactate compound. The organotitanium compound having no alkoxy group is unlikely to cause a change of the thickness of the coated layer due to changing of the molecular weight, or gelation of the coating composition, and in general has excellent storage stability, thus being preferable.

It is preferred that the organotitanium compound having no alkoxy group is a compound having at least one member selected from the group consisting of an alkyl group having 1 to 5 carbon atoms, a hydroxyalkyl group, and a hydroxyl group. Especially, it is most preferred that the organotitanium compound having no alkoxy group has in its structure at least one hydroxyl group.

It is preferred that the organotitanium compound having no alkoxy group has an ability to absorb light having a wavelength of shorter than 300 nm, for obtaining a material for the undercoating layer which may be used in combination with a KrF excimer laser (wavelength: 248 nm), an ArF excimer laser (wavelength: 193 nm), or an F₂ excimer laser (wavelength: 157 nm).

Example of the particularly preferable organotitanium lactate compound may specifically include a titanium lactate compound represented by formula (1) below, as this titanium lactate compound has an ability to absorb light having a wavelength of shorter than 300 nm.

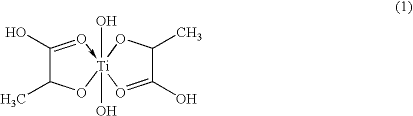

The organotitanium compound having no alkoxy group preferably has a molecular weight equal to or less than 1000, more preferably equal to or less than 400. The molecular weight is a value measured by a mass spectrometer generally used.

The undercoating layer material for lithography according to the present invention preferably may contain 25 to 250 parts by weight, especially preferably 30 to 200 parts by weight, further preferably 50 to 100 parts by weight of the organotitanium compound having no alkoxy group in terms of TiO₂, relative to 100 parts by weight of the polysiloxane in terms of SiO₂, which will be discussed later. When the amount of the organotitanium compound is smaller than 25 parts by weight, it is difficult to obtain a light absorption effect, and, when the amount is larger than 250 parts by weight, voids are likely to occur.

The organotitanium compounds having no alkoxy group may be used individually or in combination of two or more kinds.

As the organotitanium compound for use in the present invention, various compounds may be considered. When a titanium compound having an alkoxy group is employed among a variety of the titanium compounds and the compound is added to the undercoating layer material at a large amount, the burying properties of the material will become poor. In addition, such an undercoating layer material is likely to generate voids, as compared to those containing the titanium compound having no alkoxy group. Further, the titanium compound having an alkoxy group undergoes a polymerization reaction with polysiloxane and hence is difficult to control the molecular weight, so that the stability with the lapse of time is poor. The stability with the lapse of time specifically refers to stability in terms of a change of the thickness of the coated film due to changing of the molecular weight or gelation. Therefore, a characteristic feature of the undercoating layer material for lithography according to the present invention resides in the use of the organotitanium compound having no alkoxy group.

The titanium compound is used in the form of a solution in an organic solvent, and examples of organic solvents used may include monohydric alcohols, such as methyl alcohol, ethyl alcohol, propyl alcohol, and butyl alcohol; polyhydric alcohols, such as ethylene glycol, diethylene glycol, propylene glycol, glycerol, trimethylolpropane, and hexanetriol; monoethers of a polyhydric alcohol and monoacetates thereof, such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, propylene glycol monoethyl ether, propylene glycol monopropyl ether, and propylene glycol monobutyl ether; esters, such as methyl acetate, ethyl acetate, and butyl acetate; ketones, such as acetone, methyl ethyl ketone, and methyl isoamyl ketone; and alkyl ethers of polyhydric alcohol ethers obtained by completely etherifying a polyhydric alcohol ether with alkyl groups, such as ethylene glycol dimethyl ether, ethylene glycol diethyl ether, ethylene glycol dipropyl ether, ethylene glycol dibuyl ether, propylene glycol dimethyl ether, propylene glycol diethyl ether, diethylene glycol dimethyl ether, diethylene glycol diethyl ether, and diethylene glycol methyl ethyl ether. Among these, preferred are polyhydric alcohol ethers obtained by partially or completely etherifying a polyhydric alcohol ether with alkyl groups, and monoacetates thereof. These solvents may be used in the form of a mixture with water.

(II) Polysiloxane

The polysiloxane used as a resin component in the present invention contains:
(i) a compound represented by the following formula:
   Si(OR¹)ₐ(OR²)_{b}(OR³)_{c}(OR⁴)_{d} (2)
   wherein each of R¹, R², R³, and R⁴ represents an alkyl group having 1 to 4 carbon atoms or a phenyl group, and a, b, c, and d are integers which satisfy the requirements: 0<a<4, 0<b<4, 0<c<4, 0<d<4, and a+b+c+d=4;
(ii) a compound represented by the following formula:
   R⁵Si(OR⁶)ₑ(OR⁷)_{f}(OR⁸)_{g} (3)
   wherein R⁵ represents hydrogen, an alkyl group having 1 to 4 carbon atoms, or a phenyl group, each of R⁶, R⁷, and R⁸ represents an alkyl group having 1 to 3 carbon atoms or a phenyl group, and e, f, and g are integers which satisfy the requirements: 0<e<3, 0<f<3, 0<g<3, and e+f+g=3;
   and
(iii) a compound represented by the following formula:
   R⁹R¹⁰Si(OR¹¹)ₕ(OR¹²)ᵢ (4)
   wherein each of R⁹ and R¹⁰ represents hydrogen, an alkyl group having 1 to 4 carbon atoms, or a phenyl group, each of R¹¹ and R¹² represents an alkyl group having 1 to 3 carbon atoms or a phenyl group, and h and i are integers which satisfy the requirements: 0<h<2, 0<i<2, and h+i=2.

Examples of compounds (i) may include tetraalkoxysilanes, such as tetramethoxysilane, tetraethoxysilane, tetrapropoxysilane, tetrabutoxysilane, tetraphenyloxysilane, trimethoxymonoethoxysilane, dimethoxydiethoxysilane, triethoxymonomethoxysilane, trimethoxymonopropoxysilane, monomethoxytributoxysilane, monomethoxytriphenyloxysi lane, dimethoxydipropoxysilane, tripropoxymonomethoxysilane, trimethoxymonobutoxysi lane, dimethoxydibutoxysilane, triethoxymonopropoxysilane, diethoxydipropoxysilane, tributoxymonopropoxysilane, dimethoxymonoethoxymonobutoxysilane, diethoxymonomethoxymonbbutoxysilane, diethoxymonopropoxymonobutoxysilane, dipropoxymonomethoxymonoethoxysilane, dipropoxymonomethoxymonobutoxysilane, dipropoxymonoethoxymonobutoxysilane, dibutoxymonomethoxymonoethoxysilane, dibutoxymonoethoxymonopropoxysilane, and monomethoxymonoethoxymonopropoxymonobutoxysilane; and oligomers thereof. Among these, preferred are tetramethoxysilane, tetraethoxysilane, and oligomers thereof.

Examples of compounds (ii) may include trimethoxysilane, triethoxysilane, tripropoxysilane, triphenyloxysilane, dimethoxymonoethoxysilane, diethoxymonomethoxysilane, dipropoxymonomethoxysilane, dipropoxymonoethoxysilane, diphenyloxymonomethoxysilane, diphenyloxymonoethoxysilane, diphenyloxymonopropoxysilane, methoxyethoxypropoxysilane, monopropoxydimethoxysilane, monopropoxydiethoxysilane, monobutoxydimethoxysilane, monophenyloxydiethoxysilane, methyltrimethoxysilane, methyltriethoxysilane, methyltripropoxysilane, ethyltrimethoxysilane, ethyltripropoxysilane, ethyltriphenyloxysilane, propyltrimethoxysilane, propyltriethoxysilane, propyltriphenyloxysilane, butyltrimethoxysilane, butyltriethoxysilane, butyltripropoxysilane, butyltriphenyloxysilane, methylmonomethoxydiethoxysilane, ethylmonomethoxydiethoxysilane, propylmonomethoxydiethoxysilane, butylmonomethoxydiethoxysilane, methylmonomethoxydipropoxysilane, methylmonomethoxydiphenyloxysilane, ethylmonomethoxydipropoxysilane, ethylmonomethoxydiphenyloxysilane, propylmonomethoxydipropoxysilane, propylmonomethoxydiphenyloxysilane, butylmonomethoxydipropoxysilane, butylmonomethoxydiphenyloxysilane, methylmethoxyethoxypropoxysilane, propylmethoxyethoxypropoxysilane, butylmethoxyethoxypropoxysilane, methylmonomethoxymonoethoxymonobutoxysilane, ethylmonomethoxymonoethoxymonobutoxysilane, propylmonomethoxym onoethoxymonobutoxysilane, and butylmonomethoxymonoethoxymonobutoxysilane. Among these, preferred are trimethoxysilane and triethoxysilane.

Examples of compounds (iii) may include dimethoxysilane, diethoxysilane, dipropoxysilane, diphenyloxysilane, methoxyethoxysilane, methoxypropoxysilane, methoxyphenyloxysilane, ethoxypropoxysilane, ethoxyphenyloxysilane, methyldimethoxysilane, methylmethoxyethoxysilane, methyldiethoxysilane, methylmethoxypropoxysilane, methylmethoxyphenyloxysilane, ethyldipropoxysilane, ethylmethoxypropoxysilane, ethyldiphenyloxysilane, propyldimethoxysilane, propylmethoxyethoxysilane, propylethoxypropoxysilane, propyldiethoxysilane, propyldiphenyloxysilane, butyidimethoxysilane, butylmethoxyethoxysilane, butyldiethoxysilane, butylethoxypropoxysilane, butyldipropoxysilane, butylmethylphenyloxysilane, dimethyldimethoxysilane, dimethylmethoxyethoxysilane, dimethyidiethoxysilane, dimethyldiphenyloxysilane, dimethylethoxypropoxysilane, dimethyldipropoxysilane, diethyldimethoxysilane, diethylmethoxypropoxysilane, diethyldiethoxysilane, diethylethoxypropoxysilane, dipropyldimethoxysilane, dipropyldiethoxysilane, dipropyldipheyloxysilane, dibutyidimethoxysilane, dibutyidiethoxysilane, dibutyldipropoxysilane, dibutylmethoxypheyloxysilane, methylethyidimethoxysilane, methylethyldiethoxysilane, methylethyldipropoxysilane, methylethyldiphenyloxysilane, methylpropyldimethoxysilane, methylpropyldiethoxysilane, methylbutyldimethoxysilane, methylbutyldiethoxysilane, methylbutyldipropoxysilane, methylethylethoxypropoxysilane, ethylpropyldimethoxysilane, ethylpropylmethoxyethoxysilane, dipropyldimethoxysilane, dipropylmethoxyethoxysilane, propylbutyldimethoxysilane, propylbutyldiethoxysilane, dibutylmethoxyethoxysilane, dibutylmethoxypropoxysilane, and dibutylethoxypropoxysilane. Among these, preferred are dimethoxysilane, diethoxysilane, methyldimethoxysilane, and methyldiethoxysilane.

Compounds (i) to (iii) may be appropriately selected and used, and, especially, a combination of compounds (i), (ii), and (iii) in respective amounts of 20 to 40 mol %, 50 to 70 mol %, and 10 to 30 mol % is preferred from the viewpoint of achieving excellent burying properties. When the ratio of the combination falls outside of the aforementioned ranges, voids may be easily generated in the film and the storage stability of the material may be disadvantageously lowered.

The polysiloxane may be obtained through hydrolysis and condensation reactions of the above compound in the presence of an acid catalyst, water, and an organic solvent.

As an acid catalyst, any organic acid or inorganic acid which is conventionally used in the undercoating layer may be used. As the organic acid, a carboxylic acid, such as formic acid, oxalic acid, fumaric acid, maleic acid, glacial acetic acid, acetic anhydride, propionic acid, or n-butyric acid, or an organic acid having a sulfur-containing acid residue may be used. Examples of organic acids having a sulfur-containing acid residue may include organic sulfonic acids. Further, esters of the organic sulfonic acids such as organic sulfates and organic sulfites may also be used as the acid catalyst. Among these, especially preferred are organic sulfonic acids, e.g., compounds represented by the following formula (5):
R¹³—X (5)
wherein R¹³ represents a hydrocarbon group having no substituent or having a substituent, and X represents a sulfonic acid group.

In formula (5) above, hydrocarbon group R¹³ preferably has 1 to 20 carbon atoms, and the hydrocarbon group may be either saturated or unsaturated, and may be linear, branched, or cyclic. When hydrocarbon group R¹³ is cyclic, the hydrocarbon group may be an aromatic hydrocarbon group, such as a phenyl group, a naphthyl group, or an anthryl group, and, among these, preferred is a phenyl group. The aromatic ring in the aromatic hydrocarbon group may have bonded thereto at least one alkyl group having 1 to 20 carbon atoms, and the hydrocarbon group having 1 to 20 carbon atoms may be either saturated or unsaturated, and may be linear, branched, or cyclic. Examples of the substituents may include halogen atoms, such as a fluorine atom, a sulfonic acid group, a carboxyl group, a hydroxyl group, an amino group, and a cyano group. The hydrocarbon group may have one or a plurality of these substituents. From the viewpoint of obtaining an effect of improving the form of the lower portion of the resist pattern, especially, examples of the organic sulfonic acids may include nonafluorobutanesulfonic acid, methanesulfonic acid, trifluoromethanesulfonic acid, dodecylbenzenesulfonic acid, and mixtures thereof. As the inorganic acid, sulfuric acid, phosphoric acid, nitric acid, or hydrochloric acid may be used, and, among these, preferred are phosphoric acid and nitric acid.

The acid catalyst serves as a catalyst for hydrolysis of the silane compound in the presence of water, and the amount of water added is preferably in the range of 1.5 to 4.0 mol, per 1 mol of the sum of the silane compounds. The acid catalyst may be either added after adding water or added in the form of an aqueous acid solution of an acid compound and water, and it is advantageous that the amount of the acid catalyst used is adjusted so that the concentration of the acid catalyst in the hydrolysis system falls in the range of 300 to 800 ppm, especially 400 to 600 ppm. A hydrolysis reaction is generally completed within about 5 to 100 hours, but, for shortening the reaction time, it is preferred that the reaction system is heated to a temperature not higher than 80° C.

The aforementioned ingredients are dissolved in an organic solvent to prepare a polysiloxane solution, and examples of organic solvents used may include monohydric alcohols, such as methyl alcohol, ethyl alcohol, propyl alcohol, and butyl alcohol; polyhydric alcohols, such as ethylene glycol, diethylene glycol, propylene glycol, glycerol, trimethylolpropane, and hexanetriol; monoethers of a polyhydric alcohol and monoacetates thereof, such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, propylene glycol monoethyl ether, propylene glycol monopropyl ether, and propylene glycol monobutyl ether; esters, such as methyl acetate, ethyl acetate, and butyl acetate; ketones, such as acetone, methyl ethyl ketone, and methyl isoamyl ketone; and alkyl ethers of polyhydric alcohol ethers obtained by completely etherifying a polyhydric alcohol ether with alkyl groups, such as ethylene glycol dimethyl ether, ethylene glycol diethyl ether, ethylene glycol dipropyl ether, ethylene glycol dibuyl ether, propylene glycol dimethyl ether, propylene glycol diethyl ether, diethylene glycol dimethyl ether, diethylene glycol diethyl ether, and diethylene glycol methyl ethyl ether. Among these, preferred are polyhydric alcohol ethers obtained by partially or completely etherifying a polyhydric alcohol ether with alkyl groups, and monoacetates thereof.

The organic solvents may be used individually or in combination of two or more kinds. The polysiloxane solution thus prepared may be used as such, but the solution may be diluted with a diluting solvent for adjusting the solid content of the polysiloxane solution. As the diluting solvent, the organic solvent listed above may be used. In the preparation of the polysiloxane solution, it is important that the amount of an alcohol solvent used or the amount of alcohol formed in the hydrolysis reaction of the silane compound is 15% by weight or less, based on the weight of the coating composition. When the amount of the remaining alcohol is more than 15% by weight, a reaction of an H—Si group and the alcohol is likely to occur to form an RO—Si group, which may result in not only gelation of the coating composition to lower the storage stability, but also a crack in the resulting film. When excess alcohol is mixed into the composition, the alcohol may be removed by vacuum distillation, and the vacuum distillation may advantageously be carried out at a degree of vacuum of 39.9×10² to 39.9×10³ Pa, preferably 66.5×10² to 26.6×10³ Pa, at a temperature of 20 to 50° C. for 2 to 6 hours.

For forming an undercoating layer using the undercoating layer material for lithography according to the present invention, the undercoating layer material for lithography according to the present invention is applied onto a substrate and then baked.

Specifically, the undercoating layer material for lithography according to the present invention may be applied onto a substrate by a spin coating method, a flow coating method, or a roll coating method, so that the resultant film has a predetermined thickness. The thickness of the undercoating layer may be appropriately selected depending on the device used.

The applied undercoating layer material for lithography may be baked on a hot plate to volatilize the solvent and to cross-link the polysiloxane. In this instance, the baking temperature may be, for example, about 90 to 500° C. Generally, a time required for the baking may be 10 to 360 seconds, preferably 90 to 180 seconds.

2) Method for Forming a Wiring

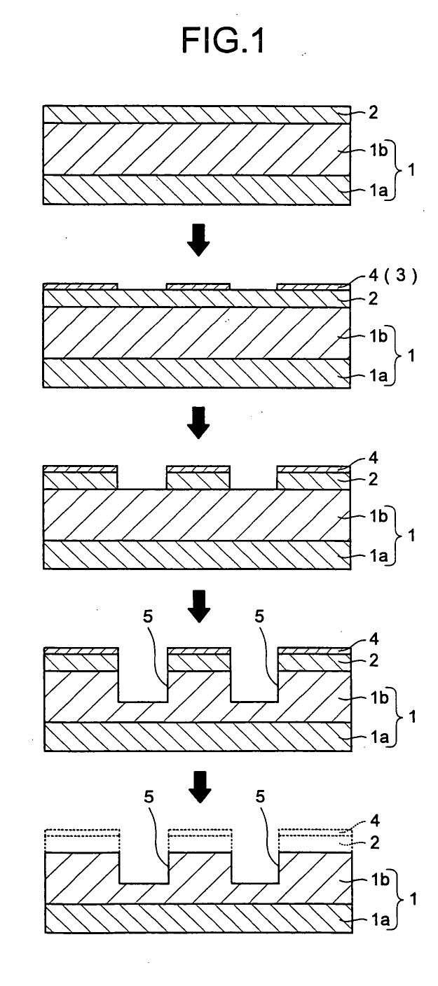

The method for forming a wiring according to the present invention will be described in detail with reference to FIG. 1. The first to the fifth steps in FIG. 1 are a series of steps of forming a wiring using lithography.

On a semiconductor substrate 1 including a dielectric layer 1b stacked on a substrate 1a, such as a silicon wafer, an undercoating layer 2 is formed using the undercoating layer material for lithography according to the present invention (the first step: the step for forming an undercoating layer).

A photoresist layer 3 is then formed on the undercoating layer 2, and the photoresist layer 3 is subjected to exposure and development treatment to form a predetermined photoresist pattern 4 (the second step: the step for forming a photoresist pattern).

The exposed portion of an undercoating layer 2 which is not covered with the photoresist pattern 4 is removed by dry etching (the third step: the step for patterning the undercoating layer).

The dielectric layer 1b in the substrate 1 is etched using the photoresist pattern 4 and the patterned undercoating layer 2 as masks to form a predetermined wiring pattern 5 (the fourth step: the step for forming a wiring pattern).

The undercoating layer 2 and the photoresist pattern 4 remaining on the substrate 1 after forming the wiring pattern 5 are simultaneously removed by a photoresist stripper (the fifth step: the step for removing the undercoating layer).

The method for forming a wiring according to the present invention has a characteristic feature such that the method includes at least a series of the steps shown in FIG. 1. In the wiring pattern 5, for example, a conductive material is buried to form a wiring layer.

In this description of the method, the simplest wiring structure is presumed, but the method can be applied to a multilayer wiring structure including multiple wiring layers wherein the upper and lower wiring layers are electrically connected to each other through via-wiring. This configuration of the method according to the present invention includes the minimum steps required.

This method is presumed to be used in a so-called damascene process. For obtaining a multilayer structure, a dual damascene process is inevitably employed. The dual damascene process has a feature such that a wiring groove called trench and a via-hole are successively formed, and the process is classified, in respect of the order of formation, into a process in which a trench is first formed and then a via-hole is formed, and a process in which, conversely, a via-hole is first formed and then a trench is formed. The undercoating layer material for lithography according to the present invention can be applied to both the processes.

Particularly, the undercoating layer material for lithography according to the present invention has excellent burying properties, as compared to the prior-art materials, and therefore, the material according to the present invention is preferably applied to the dual damascene process in which a via-hole is first formed and then a trench is formed, and further can be applied to a substrate having formed therein a via-hole having a diameter equal to or less than 100 nm. In addition, the material of the present invention can be applied to a substrate having formed therein a via-hole having a high aspect ratio, e.g., an aspect ratio (height/diameter of the hole) of equal to or more than 1.

In the step of removing the undercoating layer in the method for forming a wiring having the above configuration, employment of the undercoating layer material for lithography according to the present invention enables removal of the film by any of a dry etching treatment and a wet treatment using a cleaning liquid.

In prior art, almost all the undercoating layer materials for lithography have been suitable only for a dry etching treatment, but one of the features of the undercoating layer material for lithography according to the present invention resides in that the film can also be removed by a wet treatment. As the cleaning liquid used in the wet treatment, an alkaline aqueous solution containing a quaternary ammonium hydroxide or an acidic aqueous solution, such as diluted hydrofluoric acid, may be used. As the alkaline aqueous solution, an alkaline aqueous solution generally used as a photoresist stripper may be used.

In the method for forming a wiring according to the present invention, with respect to the photoresist composition for forming a photoresist layer, there is no particular limitation as long as the photoresist composition corresponds to the absorbing ability of the undercoating layer in the present invention.

In the method for forming a wiring according to the present invention, a process generally used in common lithography can be used in the exposure and development treatment.

In the reworking, wet stripping can be conducted using a stripper generally used. The term “reworking” used in the present specification means that the resist layer is stripped when a failure is caused in the pattern formation (the pattern is deformed or the size of pattern falls outside of the acceptable range) and the substrate is recovered and pattern formation is carried out again from the resist coating.

While the present invention is explained in detail with reference to examples below, the invention is not limited thereto. In the examples, commercially available products were used as reagents, unless otherwise specified.

### EXAMPLES

<Preparation of Undercoating Layer Material>

24.05 g (0.2 mol) of dimethyidimethoxysilane, 81.75 g (0.6 mol) of methyltrimethoxysilane, 45.68 g (0.3 mol) of tetramethoxysilane, 117.75 g of isopropyl alcohol, 61.27 g of water, and 15.97 μl of an aqueous nitric acid solution (60% aqueous solution) were mixed together, and the resultant solution was stored at room tem perature (20° C.) for 3 hours, and then diluted with 205.56 g of isopropyl alcohol and 161.66 g of acetone to obtain a silane solution. To the silane solution were added 232.26 g of a titanium compound represented by formula (1) above (TC-310, manufactured by Matsumoto Chemical Industry, Co., Ltd.), 1447.07 g of isopropyl alcohol, and 762.67 g of acetone, to prepare an undercoating layer material.

<Evaluation of Burying Properties>

A substrate having a 100-nm hole pattern (aspect ratio: 5) was then spin-coated with the undercoating layer material obtained in the above, and subjected to stepwise baking at 80° C. for 60 seconds, at 150° C. for 60 seconds, and at 260° C. for 180 seconds. The cross-section of the resultant substrate was examined under a scanning electron microscope (SEM). As a result, no voids were found in the hole. In addition, the burying properties were such excellent that no defect was found in the buried material.

<Evaluation of Resist Pattern Form>

Further, a silicon wafer was spin-coated with the undercoating layer material obtained in the above, and subjected to stepwise baking at 80° C. for 60 seconds, at 150° C. for 60 seconds, and at 260° C. for 280 seconds to form an undercoating layer having a thickness of 1500 Å. The undercoating layer was spin-coated with a positive photoresist, TArF-6a-134 (manufactured by TOKYO OHKA KOGYO CO., LTD.), and heated at 150° C. for 90 seconds to form a resist layer having a thickness of 2250 Å. The resultant substrate was subjected to exposure using NSR S-306C (manufactured by Nikon Corporation), and heated at 105° C. for 90 seconds, followed by development using a 2.38 wt % aqueous solution of tetramethylammonium hydroxide (TMAH) for 60 seconds, to obtain a 100-nm resist pattern. The cross-sectional form of the resist pattern thus obtained was examined under SEM. As a result, it was confirmed that the cross-section had an excellent rectangular form.

<Evaluation of Storage Stability>

The undercoating layer material obtained in the above was allowed to stand at room temperature for one month, and the resultant material was visually evaluated. As a result, it was confirmed that no gelation was occurred in the solution, and the burying properties and the properties of the resist pattern were not adversely affected.

### Comparative Example

<Preparation of Undercoating Layer Material>

136 g of methyltrimethoxysilane, 284 g of tetraisopropoxytitanium, 700 g of ethyl lactate, and 50 g of water were mixed together. The resultant solution was heated to 85° C. while stirring, and stored at room temperature (20° C.) for 3 hours, followed by filtration by means of a membrane filter having a pore diameter of 0.2 μm, to prepare an undercoating layer material.

<Evaluation of Buried Material Properties>

A substrate having a 1 00-nm hole pattern (aspect ratio: 5) was then spin-coated with the undercoating layer material obtained in the above, and subjected to stepwise baking at 80° C. for 60 seconds, at 150° C. for 60 seconds, and at 260° C. for 180 seconds. The cross-section of the resultant substrate was examined under SEM. As a result, occurrence of voids was found in the hole. In addition, a defect was caused in the buried material.

As explained in the above, the undercoating layer material of the present invention is useful for wiring with lithography, especially for damascene process.

Although the present invention has been described with reference to the preferred examples, it should be understood that various modifications and variations can be easily made by those skilled in the art without departing from the spirit of the invention. Accordingly, the foregoing disclosure should be interpreted as illustrative only and is not to be interpreted in a limiting sense. The present invention is limited only by the scope of the following claims along with their full scope of equivalents.

1. An undercoating layer material for lithography, comprising polysiloxane and an organotitanium compound having no alkoxy group.

2. The undercoating layer material according to claim 1, wherein the organotitanium compound having no alkoxy group is an organotitanium compound having an ability to absorb light having a wavelength of shorter than 300 nm.

3. The undercoating layer material according to claim 1, wherein the organotitanium compound having no alkoxy group is an organotitanium chelate compound.

4. The undercoating layer material according to claim 1, wherein the organotitanium compound having no alkoxy group is an organotitanium acylate compound.

5. The undercoating layer material according to claim 1, wherein the organotitanium compound having no alkoxy group has in its structure at least one member selected from the group consisting of an alkyl group having 1 to 5 carbon atoms, a hydroxyalkyl group, and a hydroxyl group.

6. The undercoating layer material according to claim 1, wherein the organotitanium compound having no alkoxy group has in its structure at least one hydroxyl group.

7. The undercoating layer material according to claim 1, wherein the organotitanium compound having no alkoxy group is a compound represented by the following formula (1):

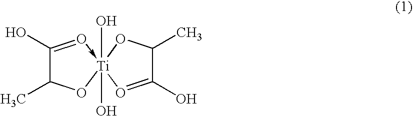

8. The undercoating layer material according to claim 1, wherein the organotitanium compound having no alkoxy group has a molecular weight equal to or less than 1000.

9. The undercoating layer material according to claim 1, wherein the organotitanium compound having no alkoxy group has a molecular weight equal to or less than 400.

10. The material according to claim 1, which comprises, relative to 100 parts by weight of the polysiloxane in terms of SiO₂, 25 to 250 parts by weight of the organotitanium compound having no alkoxy group in terms of TiO₂.

11. A method for forming a wiring, comprising:
a photoresist pattern forming step of applying the undercoating layer material for lithography according to claim 1 onto a substrate and curing the material to form an undercoating layer; forming a photoresist layer on the resultant undercoating layer; and then subjecting the photoresist layer to exposure and development treatment to form a predetermined photoresist pattern;
an undercoating layer patterning step of removing by dry etching the exposed portion of the undercoating layer which is not covered with the photoresist pattern;
a wiring pattern forming step of subjecting the substrate to etching using the photoresist pattern and the patterned undercoating layer as masks to form a predetermined wiring pattern; and
an undercoating layer removing step of removing the undercoating layer and photoresist pattern remaining on the substrate after forming the wiring pattern.

12. The method for forming a wiring according to claim 11, wherein the substrate to which the undercoating layer material for lithography is applied is a substrate having a via-hole having a diameter equal to or less than 100 nm.

13. The method for forming a wiring according to claim 12, wherein the via-hole has an aspect ratio (height/diameter) equal to or more than 1.

14. The method for forming a wiring according to claim 11, wherein the step of removing the undercoating layer is conducted by a wet treatment.

15. The method for forming a wiring according to claim 14, wherein the wet treatment is conducted using an alkaline aqueous solution containing at least a quaternary ammonium hydroxide.

16. The method for forming a wiring according to claim 14, wherein the wet treatment is conducted using an acidic aqueous solution containing at least diluted hydrofluoric acid.
